(19) United States
(12) Patent Application Publication
(10) Pub. No.: US 2003/0067176 A1
(43) Pub. Date: Apr. 10, 2003

(54) Door security bar

(76) Inventors: Thomas L. Stevens, Lovely, KY (US); Carol Stevens, Lovely, KY (US)

Correspondence Address: Richard C. Litman, LITMAN LAW OFFICES, LTD., P.O. Box 15035, Arlington, VA, 22215, US

(21) Appl. No.: 10/262,836

(22) Filed: Oct. 3, 2002

Related U.S. Application Data
(60) Provisional application No. 60/327,315, filed on Oct. 9, 2001.

(51) Int. Cl. E05C 17/54

(52) U.S. Cl. 292/339

(57) ABSTRACT

A door security bar assembly includes inner and outer wall anchor plates at each side of the doorway, which sandwich the wall structure therebetween. The external plates preclude forcing the door to pull any inner attachment screws from the inner structure, as is possible with most prior door security bars. The present bar includes a combination hinge and pivot attachment at the hinge side of the doorway, allowing the bar to be pivoted parallel to the hinge line for storage when not deployed across the door. The bar also telescopes, with a spring urging the bar to a fully extended position to ensure engagement with the retaining fixture at the latch side of the door. A lock or hasp may be installed for further security, if desired. An additional door knob retainer may be provided optionally, for precluding knockout of the door knob or lock to access the latch.

### CROSS-REFERENCE TO RELATED APPLICATION

This application claims the benefit of U.S. Provisional Patent Application Serial No. 60/327,315, filed Oct. 9, 2001.

### BACKGROUND OF THE INVENTION

1. Field of the Invention

The present invention relates generally to entryway security mechanisms, and more specifically to a door security bar providing additional anchoring security to preclude destruction of the bar attach points by force. The present security bar is attached to plates which sandwich the wall structure to each side of the door frame, thereby preventing the attachment bolts from pulling through the wall structure. Additional advantages are also provided.

2. Description of Related Art

The basic concept of the door security bar which removably installs transversely across the interior of a door to preclude pushing the door open from the exterior side, has been known for centuries. While improvements have been made over the years, the basic concept utilizes an attachment point on each side of the door (i.e., hinge side and latch side), with the attachment points generally secured only to the interior surface of the structure.

The interior attachment points or anchors are thus typically the weakest link in the chain comprising such door security bar systems. While the door and the bar are generally sufficiently strong so as to resist substantial damage, when a door is forced open the latch mechanism for the door is generally broken, allowing the door to bear against the security bar. The pressure of the door bearing against the security bar then pulls the bar attachment anchors from the wall adjacent the latch side of the door frame, thus allowing both the bar and the door to swing open. While such conventional door security bars provide a deterrent in many cases where the bar is visible, and/or where the noise from the force required to break the door latch and bar anchor may alert others, it is well known that such conventional door security bars cannot prevent the determined criminal from entering a structure, if the person has sufficient time and is not concerned with discovery.

Accordingly, a need will be seen for a door security bar system which anchors positively to both sides of the door frame, i.e., to the wall immediately adjacent the latch side and hinge side of the door frame. The present security bar provides considerably stronger attachment by means of exterior and interior plates which secure to each side of the door frame, with bolts passing through the wall to secure the two plates together on each side of the door frame, sandwiching the wall structure between each exterior and interior plate pair. Additional features are provided, e. g. a combination swivel and hinge bar attachment, telescoping bar, alternative attachment positions, and door knob guard.

A discussion of the related art of which the inventors are aware, and its differences and distinctions from the present invention, is provided below.

U.S. Pat. No. 4,295,676 issued on Oct. 20, 1981 to James A. Smith, titled “Patio Door Security Lock,” describes a system similar to the Charley-Bar® bar, which extends parallel to the track and travel of a sliding door to hold the door closed. The Smith bar, as well as others of similar configuration, rely upon compression to prevent the door from being slid open against the length of the bar. Accordingly, there is no motivation with such systems to provide positive anchoring across the span of the door and through the interior and exterior walls of the structure adjacent the door frame, as any opening forces act perpendicular to such attachments.

U.S. Pat. No. 4,429,911 issued on Feb. 7, 1984 to William C. O'Neal et al., titled “Security Door Bar System,” describes a lateral bar assembly for a conventional side hinged door. The advantage of the O'Neal et al. system is that it permits the door to be opened slightly with the bar remaining in place, so a person inside may identify a person outside the door without removing the bar. However, the O'Neal et al. bar attachment members secure only to the interior wall of the structure, to each side of the door. There is no disclosure of any means for anchoring the attachments completely through the wall of the structure nor for swivel and hinge attachment or guarding the door knob, as provided by the present door security bar invention.

U.S. Pat. No. 4,548,436 issued on Oct. 22, 1985 to Theodore M. Cole, Jr., titled “Security Lock For Double Doors,” describes a bar assembly having a bracket which secures in the jambs of the doors on each side of the double door assembly. The brackets extend inwardly past the plane of the doors, with a bar being installed through passages in the brackets to preclude opening the doors toward the inside. While the Cole, Jr. system is admirably simple and easy to install, it cannot provide the positive security and strength of the present door security bar, as the present security bar invention provides permanently installed attachment plates which sandwich the wall structure of the building therebetween, on each side of the doorway. Additional advantages (e. g., telescoping bar, hinge and pivot mechanism, etc.) are also provided by the present door security bar invention.

U.S. Pat. No. 4,779,910 issued on Oct. 25, 1988 to Rodger S. Dameron, titled “Self-Releasing Security Bar,” describes an assembly wherein the telescoping bar is urged to a retracted configuration, but is held in its extended configuration across the door by a transverse pin through the bar. Pulling the pin causes the bar to retract, thereby removing one or both ends from the brackets to each side of the doorway for rapid escape should the need arise. However, the two brackets of the Dameron door bar assembly secure only to the trim or molding around the door frame, rather than securing completely through the wall adjacent the doorway, as in the case of the present door security bar invention.

U.S. Pat. No. 5,026,102 issued on Jun. 25, 1991 to James Pitman, titled “Mechanical Security Device For Doors,” describes a pair of embodiments for a door security bar. Both embodiments include an arcuately shaped bar, with force toward the center of the bar tending to straighten the bar and thereby drive the ends of the bar more deeply into their respective retainers to each side of the door. Pitman provides through the wall anchoring for the interior bar end retaining brackets for an inwardly opening door, but fails to provide relatively large plates on the exterior of the wall for distributing the localized loads from the bolt heads. It is possible that sufficient force could be applied to a door using the Pitman assembly to pull the bolt heads through the wall structure, particularly in the case of relatively light walls, as are commonly found in mobile homes and the like. Moreover, while Pitman discloses a hinge attachment mechanism for his bar in one embodiment, his hinge does not allow the bar to pivot vertically out of the way when not in use, as does the present security bar.

U.S. Pat. No. 5,232,254 issued on Aug. 3, 1993 to Josette C. Teaff, titled “Door Securing Device,” describes a flat bar which extends between opposed retaining brackets on each side of the door. One bracket has a hinged hasp and staple for securing the hasp in place over the corresponding end of the bar. However, the Teaff device does not disclose any means for securing the attachment brackets completely through the wall with opposed plates sandwiching the wall therebetween, nor any combination pivot and hinge mechanism for the bar, as provided by the present invention.

U.S. Pat. No. 5,282,656 issued on Feb. 1, 1994 to John Fizer, titled “Original Door Bar,” describes a telescoping bar having a pivot attachment to the door frame at one end thereof. The opposite side of the frame has a retaining bracket to accept the free end of the bar. The bar retracts and is held in a storage position by another bracket attached to the door frame. Fizer does not provide a combination hinge and pivot attachment for his door bar, as does the present invention, and only discloses the use of wood screws penetrating the door frame, unlike the retaining member attachment system of the present invention, where bolted plates sandwich the wall structure therebetween adjacent to the door frame. Also, no knob guard is disclosed by Fizer.

U.S. Pat. No. 5,447,046 issued on Sep. 5, 1995 to Alexander M. Duffus, titled “Security Bar,” describes a telescoping bar in which one end is permanently hinged to the door frame and the opposite end is permanently attached to the door. A retaining bracket is attached to the latch side of the door frame, with a tongue extending from the security bar engaging a slot in the retaining bracket. The tongue is actuated by a key, which passes through a keyhole in the door and into the bar to engage the tongue lock mechanism. Duffus provides only a few relatively short wood screws which engage the door frame on the opening side of the door to secure his hinge and retaining brackets in place. Duffus does not provide plates which sandwich the wall structure therebetween nor a combination hinge and pivot attachment for his bar, as provided by the present door security bar invention.

U.S. Pat. No. 5,447,345 issued on Sep. 5, 1995 to Philip A. Daley, titled “Security Bar,” describes an assembly having a simple upwardly bent retaining arm at each side of the door frame, with the bar resting in the two arms when in place. A chain or the like is secured to one end of the bar and to a separate anchor point adjacent one of the arms, for holding that end of the bar when the bar is removed from the door and for precluding excessive opening of the door when that end of the bar is raised from its retaining arm. Daley does not provide through-wall attachment or plates sandwiching the wall structure therebetween, nor does he provide any form of hinge and pivot attachment means for his bar or door knob protection, all of which are components of the present door security bar invention.

U.S. Pat. No. 5,466,023 issued on Nov. 14, 1995 to Christopher H. Williamson, titled “Security Door Bar System And Method Of Use,” describes various embodiments of a flexible door security bar, in which the bar is capable of bowing or flexing under bending loads applied if the door is forced partially open. Williamson provides for both telescoping and fixed length bars in his disclosure. However, he does not disclose any anchoring means other than a wood screw thread eye bolt which threads into the door frame from the interior side. No double plates on each side of the wall sandwiching the wall therebetween, door knob guard or protection means, or any combination hinge and pivot attachment for one end of the bar, are disclosed by Williamson.

U.S. Pat. No. 5,605,364 issued on Feb. 25, 1997 to Jack R. Shelledy, titled “Doorway Security Device And Method Of Using Same,” describes a fixed length bar having a semi-permanently attached pin set at each end thereof. The pins drop vertically into corresponding lugs or ears on brackets which are mounted adjacent the door frame. Shelledy discloses only the use of wood screws for attaching the brackets; he does not provide double plates to sandwich the wall structure therebetween, as in the case of the present door security bar invention. While his device can hinge outwardly from the door or wall if only one end is engaged, Shelledy does not provide any means of pivoting his door bar out of the way, as provided in the present invention.

U.S. Pat. No. 5,772,266 issued on Jun. 30, 1998 to Wayne Skiba, titled “Door Security Kit,” describes a bar which attaches to a door hinge at one end and which fits over a stud extending from the door frame at the opposite end. The door hinge attachment end comprises a pin having a passage secured to the door hinge pin, allowing the pin to hinge outwardly in the same plane as the door. The door bar may pivot on the outwardly extending pin. This assembly is dependent upon the security of the door hinge attachment, and is not secured to a separate double plate assembly which sandwiches the wall therebetween, as does the present door security bar. The threaded stud of the opposite end also fails to provide the wall sandwiching strength of the double plate configuration of the present invention. Moreover, the Skiba bar does not telescope, or provide door knob tampering protection.

U.S. Pat. No. 5,791,173 issued on Aug. 11, 1998 to Cedrick B. Montes, titled “Key-Actuated Security Bar For A Door,” describes a flat bar which is pivotally hinged to the hinge side of the door frame. Montes provides a separate attachment from the door hinge for his bar hinge and pivot, but still does not provide the structural strength provided by the present invention, with its through wall attachment and double plates. No telescoping is provided by the Montes bar, nor does Montes provide any means of capturing or retaining the door knob assembly from being punched out, whereas the present invention includes all of the above features.

U.S. Pat. No. 5,826,923 issued on Oct. 27, 1998 to Gary J. Bethurem, titled “Security Apparatus For Hinged Door,” describes a mechanism having double telescoping end bar components, each having a vertical pin socket affixed thereto. The sockets fit over the hinge pivot assembly of one hinge on the hinge side of the door, and over a similarly configured vertical pin extending from the latch side of the door. The two pin sockets at each of the bar ends are slotted in order to clear the attachment leaves of the hinge assembly and opposite door latch side pin, which results in a somewhat weaker structure than that provided by the present invention. Moreover, Bethurem does not provide any spring means for urging the bar to an extended position, nor does he provide any vertical pivoting means or additional door knob retaining security means in his device, all of which features are a part of the present door security bar invention.

British Patent Publication No. 413,085 accepted on Jul. 12, 1934 to Stephen S. Abbott, titled “Improvements Relating To Doors Or The Like, And Bolts Therefor,” describes a bolt rail carried completely by the door and which does not extend beyond the hinge line of the door to secure to the adjacent wall. The bolt rail slides laterally in a pair of brackets on the door, to engage a third bracket affixed to the wall adjacent the latch edge of the door. Abbott fails to provide any through the wall attachment for his rail, nor does he provide any additional security for the door knob assembly or means for both hinging and pivoting his rail.

Finally, British Patent Publication No. 2,218,460 published on Nov. 15, 1989 to Thomas Jenner, titled “Fastening Apparatus For Securing Hinged Members,” describes a double bar assembly in which inner and outer plates are used to secure the ends of the bars. The bars are hinged at one end thereof in the inner plate on the hinge side of the door, with a lock mechanism provided for the opposite ends of the bars in the inner plate at the latch side of the door. Jenner bolts his door bars directly to the door to form a fixed assembly, with the bars always in place when the door is closed. It is not clear from the Jenner disclosure how the bolted together door and door bars can open, as they pivot about non-concentric hinge lines. Jenner does not disclose any form of pivot for his door bars in combination with his hinge attachment, nor does he disclose any form of door knob security means.

None of the above inventions and patents, either singly or in combination, is seen to describe the instant invention as claimed.

### SUMMARY OF THE INVENTION

The present invention is a door security bar assembly, which installs across a doorway to the swing side of the door, to preclude unauthorized entry to the area beyond the door. The present mechanism utilizes a series of four attachment plates which secure to the wall of the structure on each side of the doorway. An inner and an outer plate are secured adjacent the hinge side of the door, and another inner and outer plate are secured adjacent the latch side of the doorway. The respective inner and outer plates are bolted through the wall, thereby sandwiching the wall structure therebetween. The large bearing area provided by the outer plates, precludes driving the bolts through the wall in order to disable the security bar assembly.

The present door security bar assembly also includes a combination hinge and pivot mechanism which allows the bar to be pivoted upwardly or downwardly parallel to the hinge line of the door, for storage when not engaged. The present door bar also telescopes, with an internal spring urging the bar to an extended position to ensure engagement with its latch end retainer. Additional security is provided by optional installation of a lock and hasp through the latch end of the bar, thereby precluding retraction of the bar if a person is able to open the door slightly and manipulate the bar. Another security feature is the provision for a retainer which installs removably over the door knob assembly of the door, thereby precluding knockout of the door knob and lock assembly in order to access the latch mechanism to open the door.

Accordingly, it is a principal object of the invention to provide a door security bar assembly which secures to the structure adjacent the door frame by inner and outer plates to each side of the door frame, with each inner and outer plate pair sandwiching the wall therebetween.

It is another object of the invention to provide a door security bar assembly in which the attachment end of the bar is secured to its respective plate by a combination hinge and pivot mechanism, allowing the bar to be pivoted parallel to the hinge line of the door when the bar is not engaged.

It is a further object of the invention to provide a door security bar assembly including telescoping means urging the bar to an extended position, and lock means for locking the extended end of the bar to preclude retraction thereof.

Still another object of the invention is to provide a door security bar assembly including door knob security and retaining means, precluding knockout of the door knob and/or lock assembly to gain access to the door latch mechanism.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a fragmented perspective view of a door security bar according to the present invention, showing its general features.

FIG. 2 is an exploded perspective view of the hinge and pivot attachment end of the bar, showing its installation.

FIG. 3 is a detailed exploded perspective view of the hinge and pivot mechanism of FIG. 2, showing further details thereof.

FIG. 4 is an exploded perspective view of the latch side anchoring assembly for the present door security bar assembly, showing details thereof.

FIG. 5 is an environmental elevation view of the present door security bar assembly installed across a doorway and door, showing its operation.

FIG. 6 is an environmental elevation view of an alternate embodiment of the present door security bar, showing a low installation and upper retaining bracket for holding the bar when the bar is not engaged.

FIG. 7 is a top plan view in section along line 7-7 of FIG. 5, showing further details of the installation of the present door security bar assembly.

FIG. 8 is a perspective view of an alternate embodiment of the present invention, comprising a door knob retainer for precluding knockout of the door knob assembly or lock to access the door latch.

Similar reference characters denote corresponding features consistently throughout the attached drawings.

### DETAILED DESCRIPTION OF THE PREFERRED EMBODIMENTS

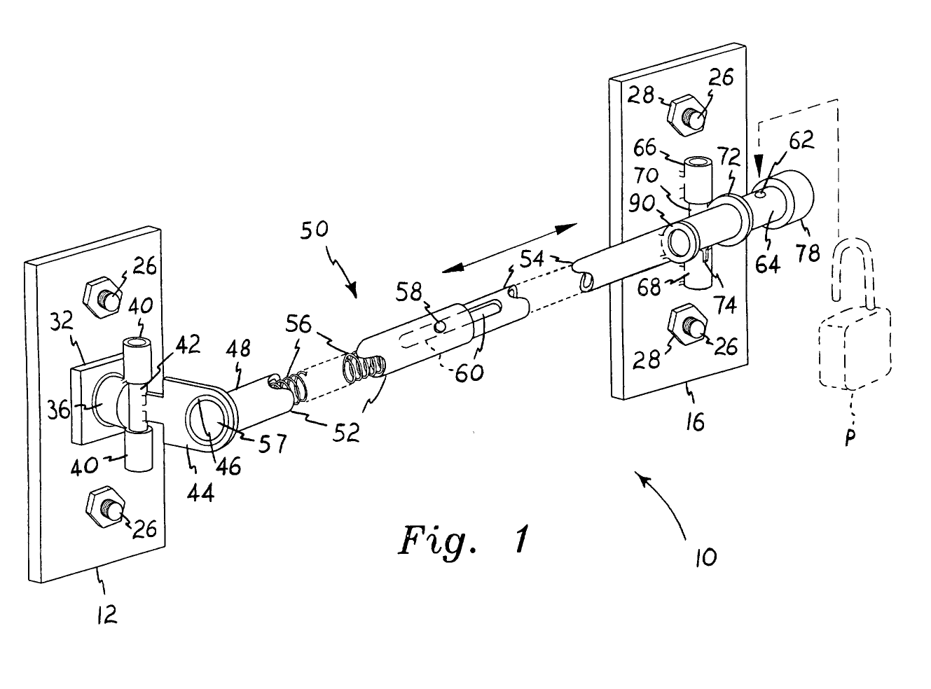

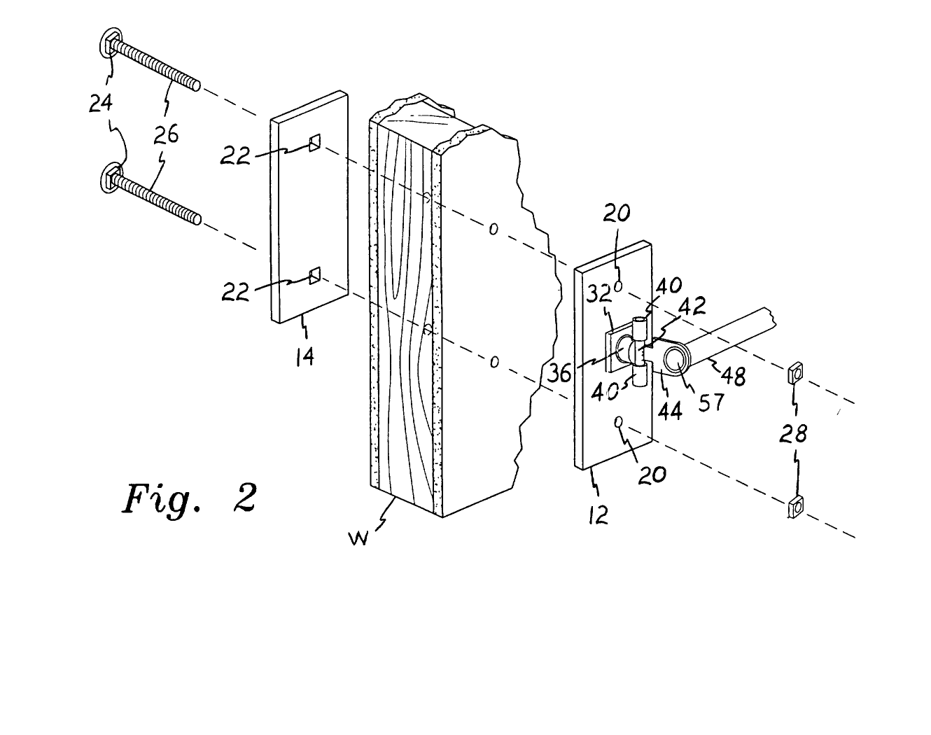

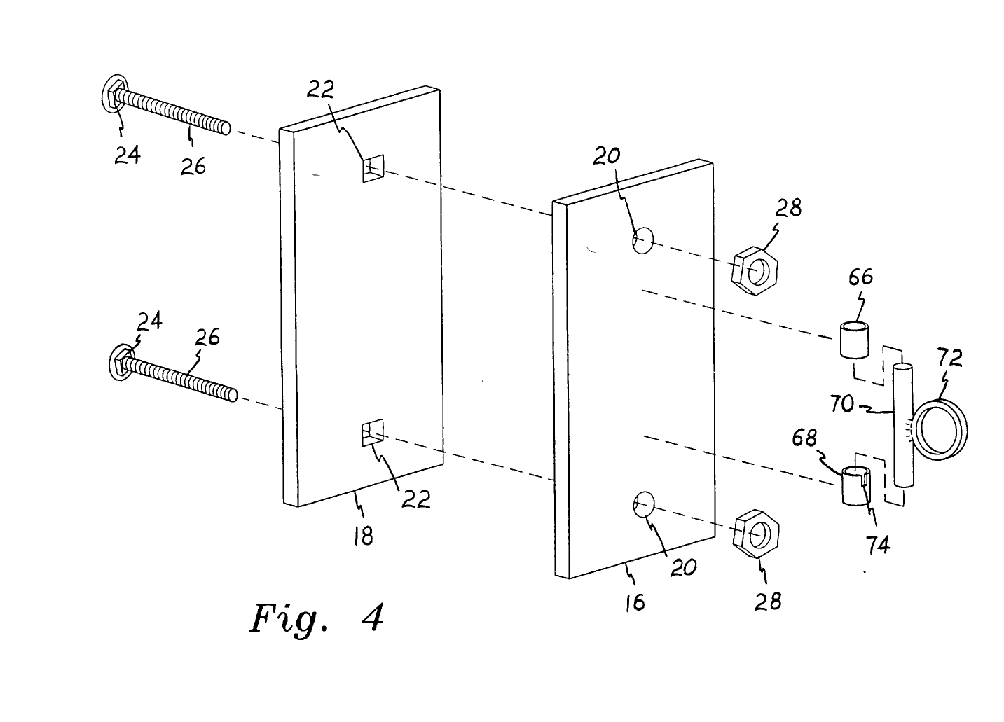

The present invention comprises various embodiments of a door security bar assembly, providing increased security over earlier such devices of the related art. FIG. 1 of the drawings provides a fragmented perspective view of the internally installed components of the present security bar assembly, with FIGS. 2 and 4 respectively illustrating the hinge end and latch end assemblies for the present bar assembly, including the externally disposed anchor or attachment plates.

The present door security bar assembly 10 provides superior attachment strength in comparison to most other bars of the prior art, by means of the four heavy metal anchor or attachment plates which sandwich the wall structure therebetween, on each side of the doorway. These four plates comprise an inner hinge side plate 12 (shown in FIGS. 1 through 3), an outer hinge side plate 14 (FIG. 2), an inner latch side plate 16 (FIGS. 1 and 4), and an outer latch side plate 18 (FIG. 4). Each plate 12 through 18 is provided with a series of bolt holes or passages therethrough. The passages for all of the plates may be drilled conventionally, as shown by the circular holes 20 through the inner plates 12 and 16 in FIGS. 2 through 4. However, the outer plates 14 and 18 may have square holes 22 punched or otherwise formed therein, as shown in FIGS. 2 and 4, in order to accept the square shoulders 24 of carriage bolts 26. Such carriage bolts 26 do not have any means of accepting turning tools in their heads, thereby providing a tamperproof installation for the present security bar assembly 10.

The anchor plates 12 through 18 are installed with the inner and outer hinge side plates 12 and 14 positioned on opposite sides of the wall W with their bolt holes 20 and 22 aligned concentrically with one another, as shown in FIG. 2 of the drawings. Holes are drilled through the wall W for the passage of the bolts 26, and the bolts 26 are installed through the outer plate 12, the wall W, and the inner plate 14, with a nut 28 being secured to the threaded end of each bolt 26. The square bolt passage holes 22, fitting the square shoulders 24 of the bolts 26, preclude rotation of the bolts 26 as the nuts 28 are tightened in place. However, the outer plates 12 and 16 may be provided with conventionally drilled or punched circular holes, if so desired, with the square shoulders 24 of the carriage bolts 26 digging into the sides of the holes to lock the bolts 26 in place as the nuts 28 are tightened. The opposite side plates 14 and 18 are secured to the wall in the same manner, generally as shown in FIG. 4 (with the wall not being shown in FIG. 4, for clarity in the drawing Fig.).

The result is that each inner and outer plate pair sandwiches the wall therebetween, providing an extremely strong anchor for each end of the door bar when installed. The provision of the relatively large outer plates 14 and 18, provides an extremely large bearing area for those plates and fasteners, thereby rendering it impossible to disable the present door bar assembly 10 when installed merely by punching the bolts or fasteners through the wall. This is particularly valuable in structures with relatively light exterior walls, such as mobile homes.

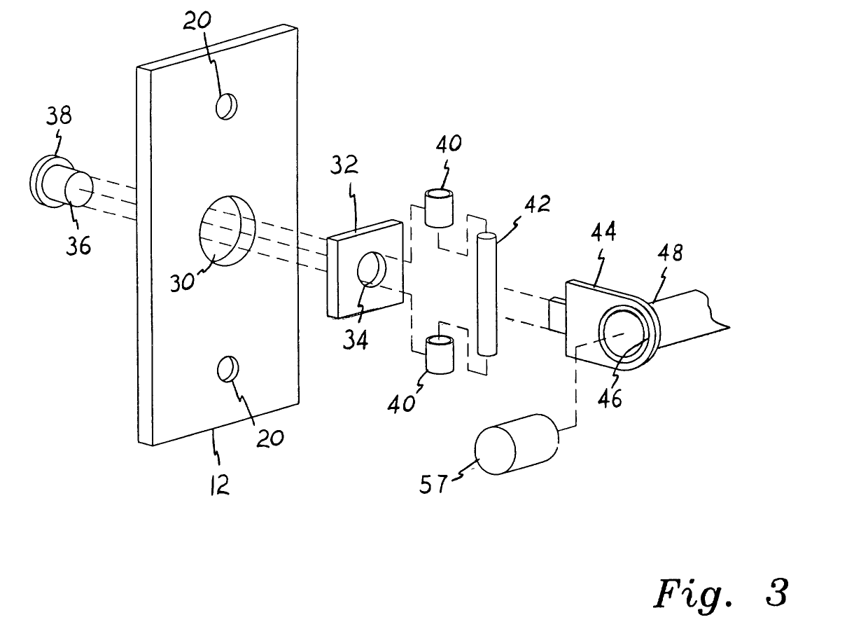

FIGS. 1 through 3 also illustrate the combination hinge and pivot mechanism connecting the door bar to the inner hinge side plate 12. The plate 12 differs from the other plates 14 through 18, in that it has a relatively large circular hole 30 punched, drilled, or otherwise formed centrally therethrough, as shown in FIG. 3. A retainer plate 32 having a smaller hole 34 formed therethrough (shown in FIG. 3), is welded concentrically over the larger hole 30 in the inner hinge side plate 12. This arrangement serves as a seat and retainer for a door bar pivot pin 36, to which the door bar is attached. The pivot pin 36 has a relatively larger diameter base 38, which seats within the hole 30 of the plate 12. The base 38 of the pivot pin 36 is captured within the plate 12 by the wall W to which the plate 12 is bolted, and by the retainer plate 32 welded thereover. However, the pin 36 and its base 38 are separate components from the plate 12 and retainer plate 32, and are free to rotate or pivot within the holes 30 and 34 thereof.

The protruding end of the pivot pin 36 includes a pair of spaced apart concentric hinge lugs or ears 40 welded thereto, with a cooperating hinge pin 42 installed therein. The hinge pin 42 in turn has a door bar attachment lug 44 welded thereto. The door bar attachment lug 44 has a door bar hole 46 formed therein, with the hinge attachment end 48 of the door bar 50 being welded into the hole 46 of the door bar lug 44. This assembly permits the door bar 50 to move independently in two degrees of rotational freedom relative to the fixed plate 12, i. e., to pivot about the axis of the pivot pin 36 and to hinge about the axis of the hinge pin 42.

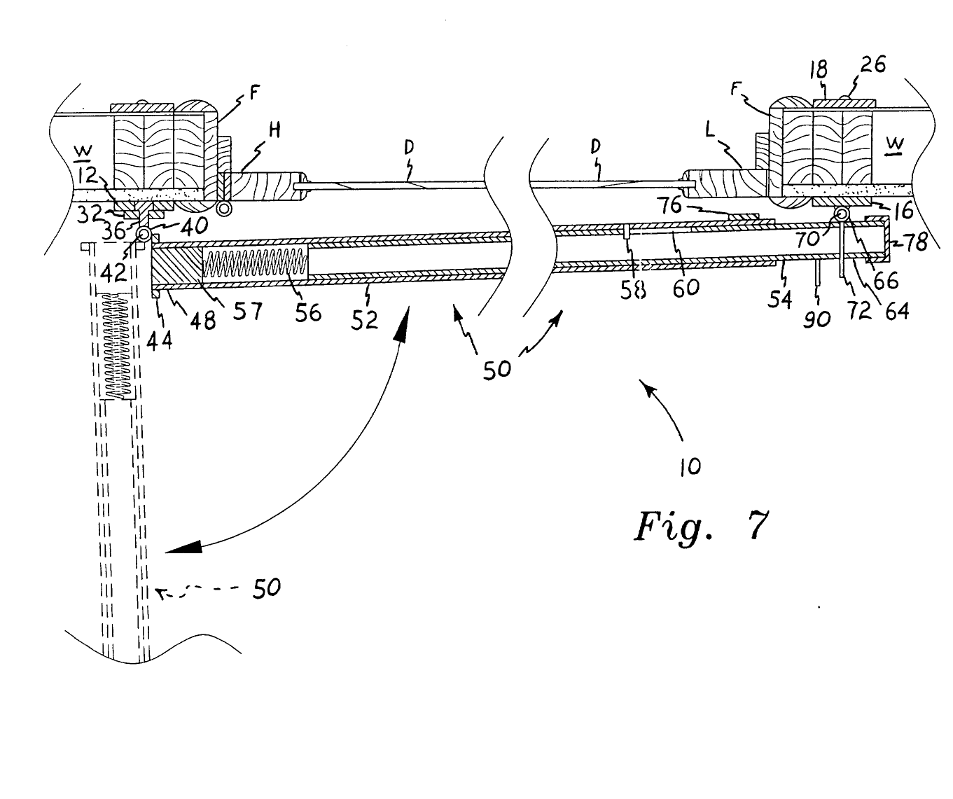

The door bar 50 is a rigid, elongate assembly formed of a first or outer tube 52 and a second or inner tube 54 telescoping concentrically into the outer tube 52, as shown in FIG. 1. A compression spring 56 in the first tube 52 bears against the inner end of the second tube 54 to extend the second tube 54 from the first tube 52. A plug 57 retains the spring 56 within the larger tube 52. The second tube 54 is retained in the first tube 52 by a transverse pin 58 extending inwardly from the wall of the first tube 52, which engages a slot 60 formed in one wall of the second tube 54. (the pin 58 and slot 60 are shown facing outwardly in FIG. 1 to provide a clear illustration of the structure. However, the pin and slot are preferably turned to face toward the door when the bar 50 is in place, as shown in FIG. 7 of the drawings.) This mechanism urges the distal, latch end or second tube 54 outwardly to engage the bar retaining mechanism extending from the opposite latch side of the door, until a compressive force is applied to the second tube 54 to retract it back into the first tube 52 in order to disengage the door bar 50, as explained in detail further below.

Normally, the present door security bar assembly is installed to the interior side of a doorway, to preclude unauthorized entry from the outside. While the present security bar renders it nearly impossible to gain entrance through the doorway from the exterior of the structure, a person wishing to exit the structure quickly need only compress the latch end tube 54 into the first tube 52 to disengage the distal second tube 54 from the latch mechanism, thereby releasing the bar 50 and allowing the door to be opened.

However, it may be desirable to provide positive bar retaining means under certain circumstances. For example, if there is some chance that an unauthorized party might somehow wedge the door open sufficiently far to access the end of the second bar 54, then that party might be able to compress the bar assembly 50 to disengage the bar and allow the door to be opened. Additional security is provided by forming a transverse lock hasp passage 62 through the distal end 64 of the second tube 54 and removably installing a lock therethrough, e. g., a padlock P, as shown in broken lines in FIG. 1, to capture the distal end 64 of the bar assembly 50 beyond the retaining catch mechanism and preclude withdrawal of the bar end 64 therefrom. Alternatively, a simple pin could be installed through the lock passage 62, to preclude any need for a key or the like to allow the bar to be disengaged.

FIG. 4 provides an exploded perspective view of the latch side and door bar retaining assembly, with the components of FIG. 4 being permanently installed through the wall adjacent the latch side of the door opening, opposite the components illustrated in FIGS. 2 and 3. The attachment or anchoring structure for the two latch side plates 16 and 18 is essentially the same as that described further above for the two hinge side plates 12 and 14, shown in detail in FIG. 2. The two plates 16 and 18 are positioned to opposite sides of the wall with their holes 20 and 22 concentrically aligned, with the bolts 26 installed through the plates 16 and 18 and through corresponding holes through the wall. Nuts 28 are used to lock the assembly permanently in place.

The interior latch side plate 16 differs from the interior hinge side plate 12, in that the plate 16 does not require any form of pivoting mechanism for the door bar catch. Instead, upper and lower catch pivot lugs, respectively 66 and 68, are welded directly to the face of the plate 16, with a catch pivot pin 70 installed through the two lugs 66 and 68. A door bar retaining ring 72 is welded to the catch pivot pin 70 and extends therefrom. The two catch pivot lugs 66 and 68 differ from one another in that the lower lug 68 includes a detent 74 formed in the upper edge thereof, to engage the lower edge of the door bar retaining ring 72 when the ring is extended outwardly from the interior latch side plate 16, as would be the case when the distal end 64 of the door bar assembly 50 is installed within the ring 72. The ring may be folded back to lie parallel to the plane of the plate 16 when not in use, in order to preclude the potential of some person or article becoming snagged or caught on the otherwise extended ring.

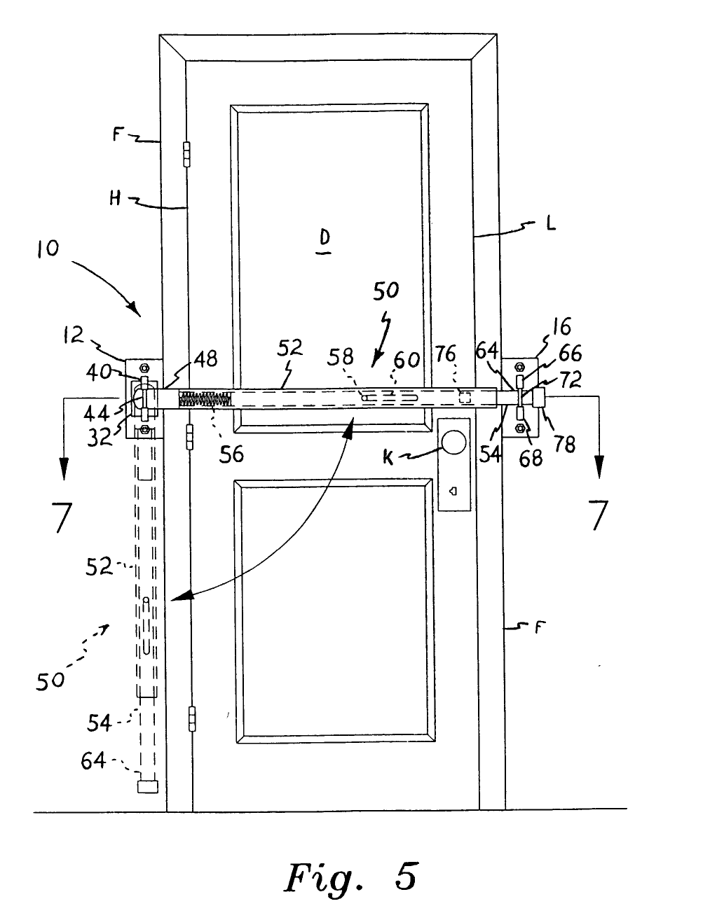

FIG. 5 provides an elevation view of the present invention as it would be installed across a conventionally hinged door D having a hinge side H, an opposite latch side L, and a door knob and latch assembly K, and set into a doorway in a frame F through a wall (with conventional wall structure W being shown in FIGS. 2 and 7). The two plate pairs, i. e., interior and exterior hinge side plates 12 and 14 and interior and exterior latch side plates 16 and 18, are installed through the wall (as shown in FIG. 2) respectively adjacent the hinge side H and latch side L of the door D, with the two interior plates 12 and 16 being visible in FIG. 5.

The door bar assembly 50 is shown in its secure position, i.e., disposed generally horizontally across the door D, in solid lines in FIG. 5. The distal latch or catch end 64 of the bar assembly 50 is captured within the bar retaining ring 72, which in turn extends from its hinged attachment to the inner latch side plate 16, to hold the door bar 50 in place across the door D. The spring 56 urges the second or smaller bar length 54 outwardly, to ensure engagement with the retaining ring 72 when the bar 50 is deployed across the door D. A resilient pad 76 (shown in broken lines in FIG. 5, and in cross section in FIG. 7) may be applied to the side of the distal end of the larger diameter tube 52, to be disposed between the door D and the tube 52, to cushion and protect the door D in the event the door D is opened slightly against the bar 50 while the bar 50 is deployed across the door D. Similarly, a resilient cap 78 may be applied to the distal end 64 of the smaller diameter tube 54, for comfort of the user when compressing the distal end 64 of the second tube 54, for installing or releasing the bar 50.

The bar 50 is easily released from its secure position across the door D, merely by pushing in on the distal end 64 of the second tube 54 (and its end cap 78) to push the distal end 64 of the second tube 54 inwardly toward the opposite hinge end 48 of the bar 50, past the retaining ring 72. The retaining ring 72 may then be hinged or folded back against the plate 16 for clearance, and the bar assembly 50 allowed to pivot downwardly about its pivot pin 36 to hang suspended in the position shown in broken lines in FIG. 5.

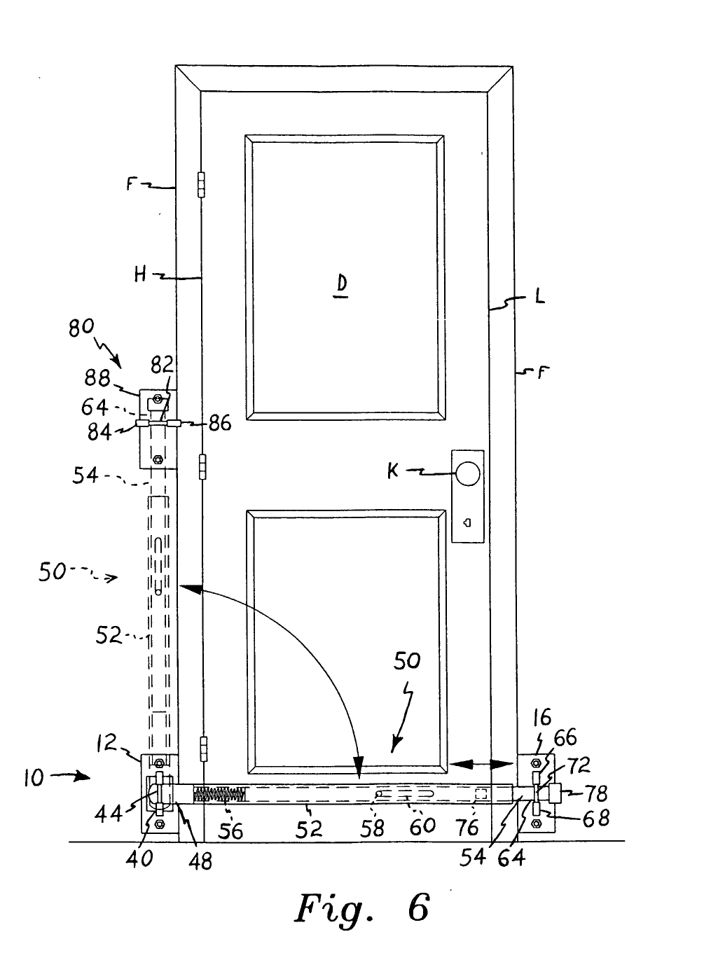

FIG. 6 illustrates an elevation view of an alternate location for the door bar assembly 10 of the present invention. In FIG. 6, the plate assemblies 12 through 18 are shown installed near the threshold of the door D, through the lower portions of the adjacent wall. Obviously, the bar 50 cannot swing downwardly to a clear position to allow the door D to be opened, due to the immediately adjacent underlying floor. While the combination hinge and pivot mechanism attaching the hinge end 48 of the bar assembly 50 to the inner hinge plate 12 will allow the bar assembly 50 to swing outwardly away from the wall as the door D is opened, the bar assembly 50 would still likely interfere with travel through the room or articles of furniture, etc.

Accordingly, the bar assembly 50 is pivoted upwardly about its pivot 36 (illustrated in FIGS. 1 through 3 of the drawings), to a generally vertical storage or clear position to allow the door D to be opened. The bar assembly 50 stored position is shown in broken lines in FIG. 6. The bar assembly 50 is held in this position by a storage assembly 80 comprising a second retaining ring 82 and hinge pin (not shown) hingedly installed in a pair of hinge pivot lugs 84 and 86, which are in turn secured to a plate or bracket 88 attached to the wall structure adjacent the medial portion of the hinge side H of the door D. While the storage assembly 80 may be identical to the latch side plate assembly 16 with its bar retaining components 66, 68, 70, and 72, the storage bracket assembly 80 may be made of considerably lighter materials and need not be secured through the wall, as in the plates 12 through 18.

FIG. 7 provides a top plan view in section of the security bar 10, showing the assembly in its installed position in solid lines across the door D. The second bar 54 of the bar assembly 50 is extended through the retaining ring 72, due to the force of the internal spring 56 within the first bar tube 52, to hold and lock the bar assembly 50 in place across the closed door D. To remove the bar 50 from its secured position across the door D, one need only apply compressive pressure to the distal end 64 of the second bar tube 54, and/or the resilient cap 78 thereon, against the spring 56 to push the second bar end 64 inwardly past the retaining ring 72, and swing the bar assembly 50 clear of the door D. A handling ring 90, also shown in FIG. 1, extends from the second tube 54 to facilitate handling the bar assembly 50. The retaining ring 72 may be repositioned with its plane generally parallel to the wall W and door D by lifting it slightly to disengage it from the retaining slot 74 (shown in FIGS. 1 and 4), to avoid catching on persons or objects passing through or near the doorway.

In FIG. 7, the bar assembly 50 is shown hinged away from the door D in a generally horizontal plane, by means of the hinge pin 42 attached to the pivot pin 36 and hinge lugs 40. It will be seen that the combination pivot and hinge mechanism secured to the inner hinge side plate 12, permits the bar assembly 50 to either hinge outwardly away from the door D or wall W, or pivot away from the door D and wall W, or to perform any combination of those two pivotal motions simultaneously and independently of one another in two degrees of rotational freedom, as desired.

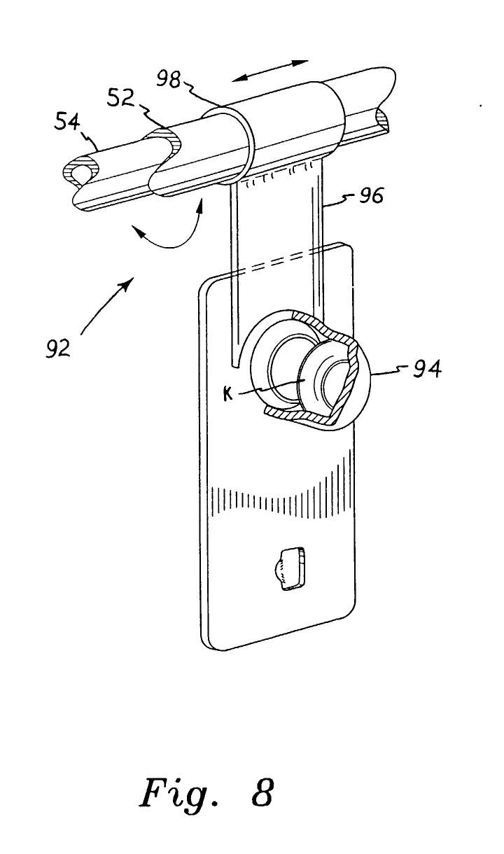

FIG. 8 provides a broken away perspective view of an alternate embodiment or additional feature of the present door bar assembly, providing positive retention of the door knob assembly of the door and precluding knock out or punch out of the knob to access the latch mechanism from the exterior. In FIG. 8, a door knob guard assembly 92 is provided, with a door knob guard 94 configured to fit over and around the doorknob K. The guard 94 is preferably formed of a heavy gauge of metal, as are all of the critical components of the present invention. The guard 94 is welded to a plate or strap 96, which in turn extends from a ring or sleeve 98 which slides longitudinally over the first or outer tube 52 along the length thereof, for selective placement of the attached guard 94 over the knob K. The anchor plates 12 through 18 of the present invention are positioned at installation at a height such that the bar assembly 50 is at the correct height above the door knob K, to allow the knob guard 94 to fit properly over the knob K.

Installation of the door knob guard 94 over the door knob K is easily accomplished at the time the door bar assembly 50 is placed across the door D. Once the door bar assembly 50 has been positioned, the sleeve 98 is slid along the first tube 52 to a position above the door knob K. The knob guard 94 is then swung downwardly to fit over the door knob K, thus capturing the knob K therein and holding the knob K essentially in place. The knob K, and attached external knob assembly, cannot be punched through or knocked through the door D to access and release the latch mechanism therein, with the knob K held in place by the guard 94.

In conclusion, the present door security bar assembly provides much improved security for the interior of various enclosed structures having conventionally hinged and latched doors. The attachment or anchor plates of the present invention, with their through wall mounting and sandwiching the wall structure therebetween, serve to thwart any effort to punch the attachment or anchor bolts inwardly through the wall. The large bearing area provided by the two outer plates, distributes any loads or forces over a relatively wide area of the wall. This is particularly critical in structures such as mobile homes and the like, with relatively light wall construction.

The combination pivot and hinge assembly by which the bar assembly secures to its respective anchor plate, provides further versatility for the present door security bar. The bar assembly may be manipulated to swing independently and completely clear of the door, and/or may be pivoted with its axis generally parallel to the hinge line of the door, with both of these arcuate or swiveling motions being accomplished independently of one another and separately or simultaneously, as desired. This arrangement provides superior versatility in securing the bar assembly across the door, and particularly in storing the bar assembly, as the bar assembly may be swung outwardly with the opening of the door, or stored parallel to the door hinge line, either depending from a relatively high mounted anchor plate, or being secured by an upper retaining bracket in the event the assembly is secured at a lower position across the doorway.

Even further security is provided by means of the door knob guard or retainer, which may be provided with the present door security bar. In the event that a person attempts to gain access to the structure by knocking out the door knob assembly to gain access to the latch mechanism, the present door knob guard will hold the knob generally in place, preventing the entire knob assembly from being knocked through the door to enable a person to access the latch mechanism through the resulting opening. Thus, the present door security bar invention responds to virtually any potential avenue of attempted forced entry through the doorway of an enclosed structure, in a sturdy, easily installed, easily operated, and most cost effective device.

It is to be understood that the present invention is not limited to the embodiments described above, but encompasses any and all embodiments within the scope of the following claims.

We claim:

1. A door security bar assembly for selectively barring a hinged door, with the door having a hinge side, a latch side, a knob and latch assembly, and being set into a wall structure, the invention comprising:
an inner hinge side plate and an outer hinge side plate, comprising a hinge side plate pair;
an inner latch side plate and an outer latch side plate, comprising a latch side plate pair;
a plurality of through bolts extending through each said plate pair for securing each said plate pair to the wall structure and sandwiching the wall structure between each said plate pair;
a rigid, elongate door bar having a hinge end and a latch end;
a door bar attachment assembly disposed upon said inner hinge side plate and permanently connecting said hinge end of said door bar to said inner hinge side plate for independently positioning said door bar relative to the door; and
a door bar retaining assembly disposed upon said inner latch side plate, for selectively securing said door bar across the door by securing said latch end of said door bar to said latch side plate.

2. The door security bar assembly according to claim 1, wherein:
said door bar attachment assembly further comprises a door bar pivot and hinge assembly disposed upon said hinge side plate providing two degrees of rotational freedom for said door bar relative to said hinge side plate.

3. The door security bar assembly according to claim 1, further including:
a door knob guard extending from said door bar, and selectively positionable over the door knob for precluding knockout of the door knob.

4. The door security bar assembly according to claim 1, wherein:
said door bar further comprises a first section and a second section telescopically assembled together.

5. The door security bar assembly according to claim 4, further including:
a spring disposed within said door bar urging said first section and said second section to an extended configuration.

6. The door security bar assembly according to claim 1, further including:
a lock passage disposed through said door bar adjacent said latch end thereof, for selectively installing a lock hasp therethrough for locking said door bar in a door securing position.

7. A door security bar assembly for selectively barring a hinged door, with the door having a hinge side, a latch side, a knob and latch assembly, and being set into a wall structure, the invention comprising:
at least one hinge side plate;
at least one latch side plate;
a plurality of bolts for securing each said plate to the wall structure;
a rigid, elongate door bar having a hinge end and a latch end;
a door bar pivot and hinge assembly disposed upon said hinge side plate and permanently connecting said hinge end of said door bar to said hinge side plate, for independently positioning said door bar relative to the door and providing two degrees of rotational freedom for said door bar relative to said hinge side plate; and
a door bar retaining assembly disposed upon said latch side plate, for selectively securing said door bar across the door by securing said latch end of said door bar to said latch side plate.

8. The door security bar assembly according to claim 7, wherein:
said at least one hinge side plate further comprises an inner hinge side plate and an outer hinge side plate, comprising a hinge side plate pair;
said at least one latch side plate further comprises an inner latch side plate and an outer latch side plate, comprising a latch side plate pair; and
said plurality of bolts further comprise through bolts extending through each said plate pair for securing each said plate pair to the wall structure and sandwiching the wall structure between each said plate pair.

9. The door security bar assembly according to claim 7, further including:
a door knob guard extending from said door bar, and selectively positionable over the door knob for precluding knockout of the door knob.

10. The door security bar assembly according to claim 7, wherein:
said door bar further comprises a first section and a second section telescopically assembled together.

11. The door security bar assembly according to claim 10, further including:
a spring disposed within said door bar urging said first section and said second section to an extended configuration.

12. The door security bar assembly according to claim 7, further including:
a lock passage disposed through said door bar adjacent said latch end thereof, for selectively installing a lock hasp therethrough for locking said door bar in a door securing position.

13. A door security bar assembly for selectively barring a hinged door, with the door having a hinge side, a latch side, a knob and latch assembly, and being set into a wall structure, the invention comprising:
at least one hinge side plate;
at least one latch side plate;
a plurality of bolts for securing each said plate to the wall structure;
a rigid, elongate door bar having a hinge end and a latch end;
a door bar attachment assembly disposed upon said inner hinge side plate and permanently connecting said hinge end of said door bar to said inner hinge side plate for independently positioning said door bar relative to the door;
a door bar retaining assembly disposed upon said inner latch side plate, for selectively securing said door bar across the door by securing said latch end of said door bar to said latch side plate; and
a door knob guard extending from said door bar, and selectively positionable over the door knob for precluding knockout of the door knob.

14. The door security bar assembly according to claim 13, wherein:
said at least one hinge side plate further comprises an inner hinge side plate and an outer hinge side plate, comprising a hinge side plate pair;
said at least one latch side plate further comprises an inner latch side plate and an outer latch side plate, comprising a latch side plate pair; and
said plurality of bolts further comprise through bolts extending through each said plate pair for securing each said plate pair to the wall structure and sandwiching the wall structure between each said plate pair.

15. The door security bar assembly according to claim 13, wherein:
said door bar attachment assembly further comprises a door bar pivot and hinge assembly disposed upon said hinge side plate providing two degrees of rotational freedom for said door bar relative to said hinge side plate.

16. The door security bar assembly according to claim 13, wherein:
said door bar further comprises a first section and a second section telescopically assembled together.

17. The door security bar assembly according to claim 16, further including:
a spring disposed within said door bar urging said first section and said second section to an extended configuration.

18. The door security bar assembly according to claim 13, further including:
a lock passage disposed through said door bar adjacent said latch end thereof, for selectively installing a lock hasp therethrough for locking said door bar in a door securing position.
